(19) United States
(12) Patent Application Publication
(10) Pub. No.: US 2016/0283335 A1
(43) Pub. Date: Sep. 29, 2016

(54) METHOD AND SYSTEM FOR ACHIEVING A HIGH AVAILABILITY AND HIGH PERFORMANCE DATABASE CLUSTER

(71) Applicant: XINYU XINGBANG INFORMATION INDUSTRY CO., LTD., Xinyu-City (CN)

(72) Inventors: Xiaohong YAO, Xinyu City (CN); Gong ZHOU, Xinyu City (CN)

(21) Appl. No.: 15/009,008

(22) Filed: Jan. 28, 2016

(30) Foreign Application Priority Data
Mar. 24, 2015 (CN) 201510130075.6

(51) Int. Cl. G06F 11/20; G06F 17/30

(52) U.S. Cl. CPC G06F 11/203; G06F 17/30575; G06F 17/30312; G06F 2201/80; G06F 2201/805

(57) ABSTRACT

A method and system for implementing a high availability and high performance database cluster are disclosed. The method comprises: installing a distributed block device replication software, a high availability cluster component, and a dependent package of database multi-master software on a host and a backup machine; building a distributed block device replication software environment in the cluster for synchronizing data of the backup machine with the host; building a high availability cluster component environment in the cluster; building a database multi-master environment among nodes of the host, the backup machine and a slave; and defining a resource on the host and the backup machine so that the host and the backup machine are switchable to each other and the slave can access database services provided by the host and the backup machine to provide uninterrupted database cluster services.

### FIELD OF THE INVENTION

The present invention relates to a database integration system, in particular to a method and system for achieving a high availability and high performance database cluster.

### BACKGROUND OF THE INVENTION

Switching between a host and a backup machine in current database master-slave architectures is carried out manually. Operation for a manual switch is relatively complex and the database downtime is relatively long, leading to a relatively large data delay, an unstable system, and particularly serious data loss during synchronization of data in a database between the host and the backup machines, which cannot meet requirement on high performance and high availability by a cluster system.

### SUMMARY OF THE INVENTION

An object of the present invention is to provide a method and system for achieving a high availability and high performance database cluster, in order to solve at least one of the above problems.

According to an aspect of the invention, there is provided a method for achieving a high availability and high performance database cluster, which comprises A. installing a distributed block device replication software, a high availability cluster component, and a dependent package of database multi-master software on a host and a backup machine in the cluster; B. building a distributed block device replication software environment among the host and the backup machine in the cluster, so that the backup machine is capable of synchronization data from the host; C. building a high availability cluster component environment among the host and the backup machine in the cluster; D. building a database multi-master environment among nodes of the host, the backup machine and a slave in the cluster; and E. performing a resource definition on the host and backup machines in the cluster, so that the host and the backup machines are switchable to each other and slaves are capable of accessing to database services of the host or the backup machine to provide uninterrupted database cluster services.

Hosts and backup machines in database clusters achieve efficient synchronization of data by utilizing Distributed Replicated Block Device (DRBD) software, thus ensuring zero data loss, and effectively monitor working status of a server by using high-availability cluster components, so that the host and backup machine are capable of fast switching when there is a failure, thus providing uninterrupted database services to the external. Meanwhile, such a database multi-master environment provides a multi-master nodes extension function for databases, so that a number of computers can handle complicated data processing simultaneously to achieve database cluster services of high performance. Thus, according to the above method, a database cluster with high availability and high performance is built.

In some embodiments, the database may comprise MySQL, Oracle or DB2. Therefore, the above method can provide cluster service with high availability and high performance among databases of different types.

In some embodiments, step B) may further comprise installing the DRBD software among the host and backup machine in a cluster, performing a configuration setting for a configuration file of the DRBD software, creating block device resource of the DRBD software, and activating the resource, so that the backup machine in the cluster is capable of synchronizing data from the host in the cluster. Therefore, the host and the backup machine can carry out replication of block with DRBD hardware by using the name of the created name of the resource.

In some embodiments, step C) may further comprise installing the high availability cluster component on the host and the backup machine in the cluster, and setting up configuration information for the installed high-availability cluster component, so that the host and the backup machine are switchable to each other to provide uninterrupted services resource when there is a fault, wherein the configuration information includes heartbeat interval, broadcast interface, heartbeat delay time, switching time, a host node name and a backup machine node name. In this way, the host can monitor the status of the backup machine through receiving heart-beating signals from it, and vice versa, which facilitates a quick switching in such a manner that when one node cannot send out signal regularly, the other node will take over the controlling of service resource immediately.

In some embodiments, step E) may further comprise configuring a host and a backup machine cluster resource information of the cluster, so that the host and the backup machine are switchable to each other via virtual IP and the slave is capable of accessing to the database services of the host and the backup machine by using the virtual IP, wherein the information comprises a master node in a specified double unit system, a cluster virtual IP, a subnet mask, a broadcast address, and initiated services. In this way, the DRBD software, the high availability cluster components, and the database's multi-master software environment configured among the host and backup machine in a cluster can be integrated and cooperated with each other so as to achieve a high availability performance of a database cluster system.

In some embodiments, each of software is installed in a source code installation manner when configuring the environment. Comparing with yum installation normally used in a LINUX operation system, source code installation should implement configuration and compiling separately by user and should resolve dependency of packages during installation thereof, which renders much more difficulties in operation. However, source code installation enables setting of parameters and selection of version of software according to needs during compiling, thereby allowing user to customize the installation according to the requirement of environment during the installation.

In some embodiments, the above method may further comprise generating, for the steps of combining respective components in configuration of the environment, a shell script which comprises at least functions of starting, stopping and checking status. The shell script can be reused after it is generated during the first building and configuration of the environment, which is convenient and quick for use. Moreover, the shell script thus generated is more brief compared with prior art.

According to another aspect of the invention, a high availability and high performance database cluster system is disclosed. The system comprises a high availability cluster and a high performance cluster, wherein the high availability cluster comprises a host and a backup machine, on which a distributed block device replication software, a high availability cluster component, and all dependent packages of MySQL multi-master software are installed, and among which an environment incorporating a distributed block device replication software module, a high availability cluster component module and a database multi-master module is built.

In some embodiments, the distributed block device replication software module enables the backup machine to synchronize data with the host, the high availability cluster component module enables the backup machine to monitor the working status of the host. The high performance cluster may comprise a virtual IP host and at least one slave, the slave is loaded with the database multi-master module.

The high availability cluster component module may comprise a resource definition unit which defines resources of the host and backup machine in the high availability cluster, so that a host can become a backup machine and vice versa in a high availability cluster, and the slave can access database of the host and the backup machine to provide uninterrupted database cluster services.

According to the above method and system, the host and the backup machine in the availability cluster can switch back and forth quickly and efficiently, the data delay is small, with almost zero data loss, and a high level safety of data can be achieved; slave nodes in the high performance cluster can synchronize data from a machine with a virtual IP, multiple computers can efficiently handle complex data problems at the same time. Thus, the function for providing high availability and high performance clustered database services to the external is achieved.

### BRIEF DESCRIPTION OF THE DRAWINGS

FIG. 1 is a flow diagram of an implementation method for a MySQL database-based high availability and high performance cluster according to an embodiment of the invention;

FIG. 2 is a system architecture diagram of the MySQL database-based high availability and high performance cluster achieved in the embodiment shown in FIG. 1.

### DETAILED DESCRIPTION

The present invention will be further described in detail in conjunction with the accompanying drawings as follows. The following description provides specific details for a thorough understanding and an enabling description of these implementations. It would be appreciated by a skilled in the art that the invention may be practiced without certain details disclosed herein. Moreover, detailed descriptions of some well-known structures or functions are omitted to avoid unnecessarily obscuring the substantive features which are embodied in the relevant description of various implementations. Furthermore, the terminology used throughout the whole description is intended to be interpreted in its broadest reasonable manner, though it may appear in conjunction with certain specific embodiments of the invention.

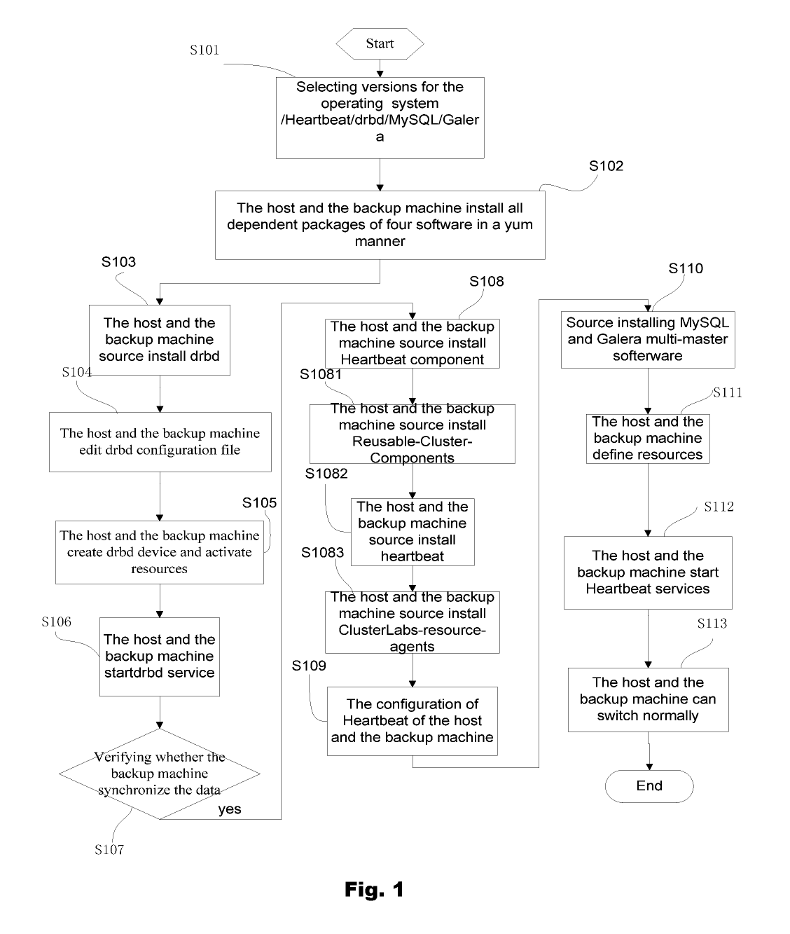

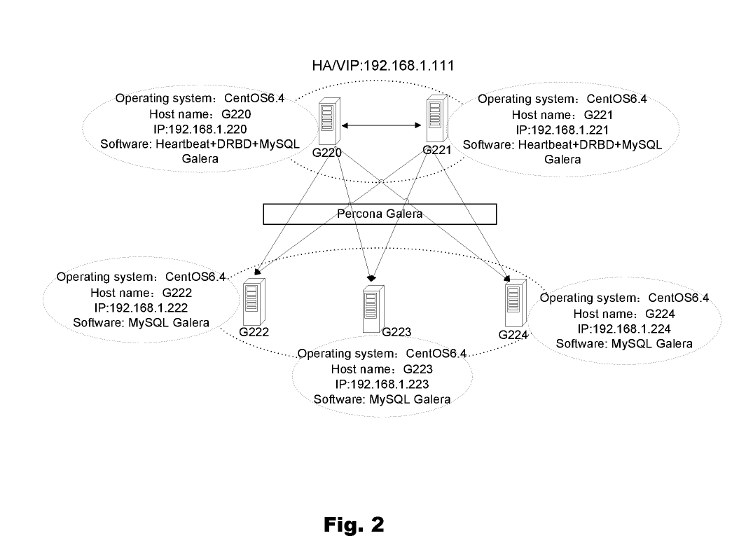

FIG. 1 schematically shows a method for implementing a MySQL database-based high availability and high performance cluster according to an embodiment of the invention. FIG. 2 schematically shows a block diagram for a system of the MySQL database-based high availability and high performance cluster implemented by the method as shown in FIG. 1.

In this embodiment, for building a server environment, CentOS 6.4 x86_64 version is elected for the operating system, DRBD software adopts DRBD8313 version, the high availability cluster components adopts Heartbeat-3037 version, the database adopts MySQL, and the multi-master software adopts MySQL Galera5.5.29 version.

Before the invention was presented, it is very difficult to combine the above software and large number of shell scripts need to be written. Conventional database cluster architecture adopts a master-slave configuration in which a slave will temporarily replace the host to provide database services by copying data from the host for redundant configuration when a failure occurs on the host. However, in the master-slave architecture, the data copied from the host at the slave is not in a synchronizing way, and thus it can only provide a high level of redundancy database services. In the present invention, multiple MySQL nodes are organized into a multi-master cluster by using Galera. All nodes are capable of automatic data synchronization, and all nodes can simultaneously read from and write into database. As a result, in a synchronous multi-master cluster software architecture, a combination of DRBD and high-availability cluster components Heartbeat can achieve high availability and highly redundant database cluster services.

Distributed Replicated Block Device (DRBD) is a Linux-based software component, which consists of a kernel module and associated procedures, and promotes the replacement of shared storage system via network mirror. That is, when the data is written to the file system on the local DRBD device of a network, the data will also be simultaneously sent to another host in the network, and recorded in a file system in an exactly same form, thereby ensuring a real-time synchronization of data between a local node (host) and a remote node (backup machine), and consistency of read and write. When a failure happens at the local node, the exactly same data is still retained on the remote node for continuous use in order to achieve high availability purposes. DRBD needs to be built on top of the underlying device, and then builds a block device. For users, a DRBD device likes a piece of a physical disk, on which a file system can be created. The underlying devices supported by DRBD comprise: a disk or a partition of the disk, a floppy disk device, a logical volume, a volume of an Enterprise Volume Management System (EVMS), and any other block devices. When there is a fault, the real switch is achieved by Heartbeat, which implements a failover by binding a virtual IP on the server, and providing services to the external via the virtual IP, so as to achieve high availability purposes.

Due to a relatively great data delay in the current MySQL Master/Slave architecture, Percona Galera is chosen. Galera adopts multi-master technology that can automatically switch between/among multi-master nodes, thus the data delay can be greatly improved and a better availability of the database cluster can be effectively obtained. Installing DRBD software on each database node can provide a file replication solution of the block device for each database node, which is much faster than a file-level software and can effectively reduce data synchronization time in each node of the database, so as to achieve zero data loss of database cluster and hence provide good network layer redundancy protection for the database. Working status of each node can be effectively monitored through the heartbeat mechanism by installing high availability cluster components (Heartbeat) in each database node. When a failure happens in a node, quickly switch within a second can be achieved by real-time monitoring failures to reduce database downtime.

The host, backup machine, virtual IP host and slave described herein can adopt special purpose computer or data processor that is specifically programmed, configured, or constructed to perform one or more of the computer-executable instructions explained in detail below. Indeed, the terms “computer” or “machine” as used generally herein, refer to devices that have a processor and non-transitory memory, like any of the above devices, as well as any data processor or any device capable of communicating with a network. Data processors may include programmable general-purpose or special-purpose microprocessors, programmable controllers, application-specific integrated circuits (ASICs), programmable logic devices (PLDs), or the like, or a combination of such devices. Software referred to as “software”, “unit”, “module” in suitable context of this specification may be stored in memory, such as random access memory (RAM), read-only memory (ROM), flash memory, or the like, or a combination of such components. Software may also be stored in one or more storage devices, such as magnetic or optical-based disks, flash memory devices, or any other type of non-volatile storage medium or non-transitory medium for data. Software may include one or more program modules, which include routines, programs, objects, components, data structures, and so on that perform particular tasks or implement particular abstract data types.

The system can be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described below may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks. Those skilled in the art will recognize that portions of the invention may reside on a server computer, while corresponding portions reside on a client computer. Data structures and transmission of data particular to aspects of the invention are also encompassed within the scope of the invention.

As shown in FIG. 2, the environment is built by the system as follows:
Host G221: eth0: 192.168.1.221 CentOS 6.4 x86_64+drbd8313+Heartbeat-3037+MySQL Galera5.5.29
Backup machine G220: eth0: 192.168.1.220 CentOS 6.4 x86_64+drbd8313+Heartbeat-3037+MySQL Galera5.5.29
Slave G222: eth0: 192.168.1.222 CentOS 6.4 x86_64+MySQL Galera5.5.29
Slave G223: eth0: 192.168.1.223 CentOS 6.4 x86_64+MySQL Galera5.5.29
Slave G224: eth0: 192.168.1.224 CentOS 6.4 x86_64+MySQL Galera5.5.29

The contents of /etc/hosts file of the host and backup machine are viewed by using a cat command, and defined in accordance with a dns configuration as follows:

| | |
|---|---|
| 192.168.1.220 | G220 |
| 192.168.1.221 | G221 |
| 192.168.1.222 | G222 |
| 192.168.1.223 | G223 |
| 192.168.1.224 | G224 |

As shown in FIG. 1, a method for building a MySQL database-based high performance and high availability cluster comprises the following steps:

Step S101: Selecting software versions used for building the high performance and high availability cluster environment.

In this embodiment, the operating system adopts CentOS 6.4 x86_64 version, DRBD software adopts DRBD8313 version, the high availability cluster component adopts Heartbeat-3037 version, the database adopts MySQL, and the multi-master software adopts MySQL Galera5.5.29 version to ensure compatibility among the various software versions, so that the built high availability and high performance database cluster environment can be more stable.

Step S102: Installing a dependent package by means of yum (Yellow dog Updater, Modified) in the host and the backup machine.

In the host and backup machine of the cluster, all dependent packages of four types of software (Heartbeat/DRBD/MySQL/Galera) are installed respectively in a yum manner.

Wherein, yum (Yellow dog Updater, Modified) is a Shell front-end package manager in Fedora, RedHat and SUSE. This command, belonging to the prior art, is a command that provided by Linux system to find, install, or remove one software package, a group of software packages or even all packages. By using the yum, RPM packages can be automatically downloaded from a specified server and installed; a dependency relationship can be automatically processed; and all dependent packages can be installed once, without cumbersome downloading and installing being conducted again and again.

Step S103: Conducting source-code Installation of DRBD in the host and backup machine.

Both a main server (host) and a slave server (backup machine) are provided with a/dev/sdb1 new disk respectively as an underlying device for DRBD, and then DRBD is source-installed according to the steps in the installation and operation documentation from the DRBD software providers. Source-installation refers to installing the software via the source package, thus improving portability by installing the source package. For various architectures, software developers just need to release only one same source package, then the package can run properly after being compiled by different end users. Source Installation requires users to define parameters and set up a configuration file by themselves according to the configuration information in the process of configuring, compiling and installing; and also to resolve package dependencies. The operation for source installation is more difficult compared to the yum source installation commonly used by Linux operating system. But yum installation is a one-time installation according to the defined configuration and parameter information, and thus can be installed only once on a single computer.

The present invention adopts the source installation. The source installation can set up its own configuration and parameter information, and is convenient in selecting a version. Thus it can be installed multiple times as necessary on a computer after the configuration information is changed. As a result, the users are allowed to customize the required software function modules for the installation. In the present invention, according to the requirements for the environment configuration, the software installations necessary for implementing the present invention can be completed by user's self-editing of configuration information and setting up of parameters according to the software configuration file and the meaning of related parameters during the installation.

Step S104: Then, the host and the backup machine edit DRBD configuration files and perform a configuration setting for DRBD.

Using lsmod|grepdrbd commands to check whether the DRBD module is successfully loaded. If the DRBD module has been successfully loaded, DRBD configuration file will be edited according to the configuration information of the host and the backup machine, so that DRBD software installed in the host and the backup machine can work normally.

The steps for editing the configuration files are performed in accordance with the steps in DRBD software providers' installation manual instructions, specifically: copying the DRBD configuration files from the source location to the DRBD installation directory init.d; emptying the contents of the drbd.conf file and adding the contents of global, common, resource sections into the drbd.conf file according to the network configuration of the host and the backup machine. In this embodiment, the host and the backup machine are G221 and G220, and the contents of the configuration setting of each section in the drbd configuration file are recited as follows:

```
  global {
  usage-count yes;
  }
  common {
```

protocol C;
startup { wfc-timeout 0; degr-wfc-timeout 120; }
disk { on-io-error detach; }
syncer { rate 30M; }

```
  }
  resource r0 {
  on G221 {
```

| | |
|---|---|
| device | /dev/drbd0; |
| disk | /dev/sdb1; |
| address | 192.168.1.221:7788; |

meta-disk internal;
}

on G220 {

| | |
|---|---|
| device | /dev/drbd0; |
| disk | /dev/sdb1; |
| address | 192.168.1.220:7788; |

meta-disk internal;
}

}

Step S105: Creating DRBD device and activate resources in the host and the backup machine.

Using an “fdisk -c /dev/sdb1” command on the host and the backup machine to partition a new disk /dev/sdb1 of the host and the backup machine according to the configuration contents of “resource” section of the configuration file in S104. The sdb1 partition is considered as a separate disk for providing an underlying device service to DRBD. Creating a DRBD hardware device on the host and the backup machine, that is, using a “mknod/dev/drbd0 b 147 0” command to create a drbd0 device as a block device of DRBD. Then, a resource r0 “drbdadm create-md r0” which can use the drbd block device is created on DRBD by using a drbdadm command. It is checked whether the DRBD configuration file is in order. If the configuration information is in order, a block device resource mapping between the created resource r0 and the block device drbd0 on the underlying device sdb 1 of DRBD is established, so that the host and the backup machine can use disk space of the corresponding block device drbd0 to read and write data via the resource 1⁻0 for achieving data synchronization. Since the data in a host named “primary” is deemed as standard data for disk data by DRBD by default, the host and the backup machine should be initialized first before starting the DRBD service to set the resource name of the host as “primary” and the resource name of the backup machine as “secondary”. In this way, the backup machine can use disk space of the corresponding DRBD via the defined resource to synchronize all data in the disk space on the host primary to the backup machine secondary. The host and the backup machine can perform an efficient replication therebetween via the block device provided by the disk space to achieve data synchronization.

Step S106: The host and the backup machine start DRBD service.

Starting DRBD services in the host and the backup machine with a “service drbd start” command.

Step S107: Make a verification on whether the slave server has synchronized data from the main server.

The running status of DRBD is viewed by carrying out a “service drbd status” command in the slave server (backup machine) or through log files. If it is Secondary/Primary, it means that the backup machine “secondary” is synchronizing data from the main server (host) “primary” via the defined block device resource, that is, drbd software has been installed successfully in the host and the backup machine respectively and can normally use DRBD hardware device via the created resource name r0 to perform a block device resource replication.

Step S108: The host and backup machine source-install Heartbeat.

In Heartbeat3.X version, the installation package is divided into four parts, namely: Cluster Glue, Resource Agents, heartbeat, and pacemaker, which are required to be installed respectively. In the present invention, it is only necessary to source install installation packages of the following modules for Heartbeatin the host and backup machine according to the steps indicated by the installation manual instructions provided by Heartbeat software providers:

Step S1081: Installing Cluster Glue module, namely Reusable-Cluster-Components package.

Step S1082: Installing heartbeat module, namely heartbeat-3 package.

Step S1083: Installing Resource Agents module, namely ClusterLabs-resource-agents package. In the present embodiment, in order to overcome the compatibility issues among different versions, after the installation of modules in this step is completed, it is necessary to modify two variables in the configure.ac file into file paths in the installation environment. For example:

Replacing
OCF_RA_DIR_PREFIX=“${prefix}/$OCF_RA_DIR”
with
OCF_RA_DIR_PREFIX=“$OCF_RA_DIR”,
and Replacing
OCF_DIR_PREFIX=“${prefix}/$OCF_LIB_DIR”
with
OCF_LIB_DIR_PREFIX=“$OCF_LIB_DIR”

Step S109: Configuring Heartbeat for the host and the backup machine.

Heartbeat has three configuration files: ha.cf, haresources and authkeys. Users can set the three configuration files according to the steps in the Heartbeat software providers' operating manual instructions as required. In this embodiment, in order to realize the function of the invention, the main contents of the configuration information are set to: modify the permissions of authkeys to 600, and add the following configuration information to the main configuration file ha.cf:
debugfile /var/log/ha-debug
logfile /var/log/ha-log
logfacility local0
keepalive 2
deadtime 60
warntime 15
initdead 120
bcast eth0
keepalive 2
node G221
node G220
debug 0
compression bz2
compression threshold 2

With the above configuration, heartbeat interval “keepalive” is set to two seconds, broadcast interface “beast” is set to eth0, heartbeat delay time “warntime” is set to 15 seconds, switching time “deadtime” is set to 60 seconds, a host node is designated as a server named G221 and a backup machine node is designated as a server named G220. Thus, the host node and the backup machine node can receive each other's heartbeat signal through eth0 network port. When the backup machine node G220 fails to receive a heartbeat signal from the host node G221 within 15 seconds, a warning will be written into a log without switching services at this time. When the backup machine node G220 fails to receive a heartbeat signal from the host node G221 within 60 seconds, it immediately takes over the service resources of the host node G221. Through this step, when a fault occurs at the host node, the backup machine node can timely detect a fault signal, quickly switch from the host, and take over the host to manage services resource, thus providing a same service to the external uninterruptedly, which will not affect the normal use of the external.

Step S110: Source installing MySQL Galera multi-master node.

MySQL Galera multi-master cluster software is source-installed in the host, the backup machine and the slave of the cluster respectively, so as to form a database cluster having multi-master nodes. The host and the backup machine installed with the multi-master cluster can provide a high availability and high performance database cluster services for the external by combining the software installed through the above steps. Wherein the databases installed in the host, the backup machine and each slave can be Oracle, DB2, or other types of databases. In this embodiment, the databases installed in the host, the backup machine and each slave is MySQL. The database and multi-master software are then installed according to the steps in the installation operating instructions for MySQL database and Galera multi-master software. After the installation, a cat command is used to view the my.cnf configuration information to confirm the database configuration parameters. Then, the node name and node address are modified as machine name and IP address of machines which have installed with multi-master nodes to build a database multi-master node cluster environment (multi-master environment).

A computer installed with a MySQL database and a Galera multi-master software becomes a database node in the multi-master cluster. Because a multi-master cluster is realized with Galera, each node is no longer a master-slave node, but is equivalent to a master node, which can simultaneously read and write the database, and copy data synchronously. New added nodes can automatically copy data in parallel. Users can directly access to the clusters, with the same feeling as in using MySQL alone. Building a database multi-master node environment can improve the data delays and loss of data caused by the slave asynchronously copy data from the host under the master-slave structure database cluster environment of the prior art, and change the previous way of protection of the database cluster environment only through high redundancy, thereby reaching a high availability and high redundancy for the database cluster.

Step S111: Defining resources.

Editing the “haresources” resource configuration file of the software Heartbeat which have been installed in the host and the backup machine, setting up information on the host and the backup machine cluster resource of the cluster system, which may comprise information on master node, cluster IP, subnet mask, broadcast address, and initiated services of a specified dual system, wherein the information in the configuration files on both HA nodes (i.e., the host node and the backup machine node) must be identical.

In the present embodiment, the following resource information is defined in haresources:

| | |
|---|---|
| echo ′G221 IPaddr::192.168.1.111/24/eth0:0 | drbddisk::r0 |
| Filesystem::/dev/drbd0::/data/mysqldata::ext4 | mysqlCluster′ > |

/usr/local/heartbeat/etc/ha.d/haresources

With the above information, the server node G221 is set to be a main node and a virtual IP192.168.1.111 is set for the network card eth0: 0. A location for block backup of drbd is set as a device which is created in step 5105 with a resource name of r0, and the startup service is mysq1Cluster, i.e., MySQL multi-master database cluster. With this resource configuration file, the installed drbd, Heartbeat, MySQL database and Galera multi-master software are integrated so that the database cluster can simultaneously use the function advantages of each software, i.e., the block device replication solution for drbd, the heartbeat monitoring mechanisms for Heartbeat and the extensible multi-master nodes function, which provides a cluster-type high availability and high redundancy protection scheme for the MySQL database. With this resource definition configuration files, the installed four sets of software can collaborate and be compatible with one another other to provide a high availability and high performance database service to the external.

In this method, the core steps of the respective combinations of software in building the environment can be edited to generate a shell script for mysqlCluster which includes at least three functions of starting, stopping and status checking. Operations like starting, stopping, and checking status of the database cluster are facilitated by using the script. When combining three software, i.e., drbd, Heartbeat and MySQL Galera again, the integration and normal switching for the three software can be implemented by executing the generated script mysqlCluster. Compared with the combination among the various software and the shell script needed to be written for them in the prior art, the software environment system combination provided by the above-mentioned method can be achieved by defining resource configuration information, which can greatly simplify operations. In addition, the shell scripts needed to be written also can be reduced a lot, so it is very fast and convenient.

Step S112: Starting Heartbeat service on the host and the backup machines.

Starting Heartbeat services via a service command on the host and backup machine, and viewing the virtual IP using ifconfig-a to confirm whether Heartbeat is in normal running. If it is in normal running, then a MySQL multi-master nodes service is re-initiated manually on the other slave installed with the multi-master nodes. The MySQL database of the slave installed with the multi-master nodes is set to use virtual IP192.168.1.111 of the host, the specific operation commands are:
service mysql restart--wsrep_cluster_address=“gcomm://192.168.1.111”

Step S113: Switching between master node and backup node is conducted repeatedly.

Using a “service” command to stop the Heartbeat service on the host, or directly unplugging the network cable of the hosts, and then assigning the virtual IP to the networks card eth0: 0 of the backup machine. The running status of DRBD is monitored by using “service”. If the host's state is Secondary/Primary, and the backup machine's state is Primary/Secondary, then it is determined that the host has become the backup machine, and the backup machine has become the host. Therefore, if a fault occurs on the main server, the slave server can replace the main server to provide data services to the external timely.

At this stage, a high availability and high-performance cluster environment based on the MySQL database is built successfully.

According to the present invention, DRBD and Heartbeat are installed in both the host node and the backup machine node of the database multi-master cluster by utilizing block replication solutions offered by drbd and the heartbeat monitoring mechanisms of Heartbeat, thus providing an uninterrupted and high-performance data-level protection for MySQL Galera multi-master database cluster. Defects like slow switching speed and data loss, etc. caused by manual switching in keeping continuous data services of the database in conventional master-slave configuration. In this way, the database cluster services can be more effective in data protection.

In the above embodiments, a high availability cluster is constituted by the host G221 and the backup machine G220 which use a virtual IP: HA/VIP: 192.168.1.111. When a fault occurs at any of the host and the backup machine, the host and the backup machine can switch fast through the virtual IP, thereby providing uninterrupted high availability services to the external. A high performance cluster can be built among the multi-master node slave G222, slaves G223, G224 and the machines having a virtual IP of the host and the backup machine. The multi-master node slave G222, slave G223, and slave G224 use the virtual IP of the host G221: HA/VIP: 192.168.1.111 to access the data of the machine having the virtual IP. A high performance data services to the external can thus be provided by connecting multiple machines via extendable multi-master nodes to handle complex data access issues simultaneously.

According to the above embodiments, there is provided a method and system for realizing a high performance and high availability cluster of MySQL databases, characterized in that DRBD, Heartbeat and virtual IP can be used on MySQL Galera multi-master cluster to achieve high availability and high performance for the database; two master nodes equipped with DRBD and Heartbeat can switch back and forth quickly and efficiently with almost zero data loss and hence a high level of data protection is available. Four software products: Heartbeat, DRBD, MySQL, and Galera are integrated while compatibility thereof is kept. It is relatively complicated for the installation, configuration and maintenance of the system are at first time, but once and for all. Namely, with such installation and configuration only once, the system can be in use quickly afterwards.

Further, it should be noted that the functions of the invention can also be achieved through other software scheme, such as RHCS+MySQL+Galera, and Pacemaker+corosync+DRBD+MySQL+Galera and DRBD+MySQL+Heartbeat+Pacemaker+LVS+Keepalive.

The above are only some embodiments of the present invention. One skilled in the art will readily appreciate that various variations and modifications can be made without deviating from the scope of the embodiments, which fall within the protection scope of the present invention.

Certain aspects of the invention are presented below in certain claim forms, but the applicant contemplates the various aspects of the invention in any number of claim forms. Accordingly, the applicant reserves the right to pursue additional claims after filing this application to pursue such additional claim forms, in either this application or in a continuing application.

We claim:

1. A method for implementing a high availability and high performance database cluster, comprising:
A) installing a distributed block device replication software, a high availability cluster component, and a dependent package of database multi-master software on a host and a backup machine in the cluster;
B) building a distributed block device replication software environment among the host and the backup machine in the cluster, so that the backup machine is capable of synchronizing its data with the host;
C) building a high availability cluster component environment among the host and the backup machine in the cluster;
D) building a database multi-master environment among nodes of the host, the backup machine and a slave in the cluster; and
E) defining a resource on the host and the backup machine in the cluster, so that the host and the backup machine are switchable to each other and the slave is capable of accessing to database services provided by the host and the backup machine to provide uninterrupted database cluster services.

2. The method of claim 1, wherein the database comprises MySQL, Oracle and DB2.

3. The method of claim 2, wherein the step B) further comprises:
performing a configuration setting for a configuration file of the distributed block device replication software installed in the host and the backup machine of the cluster, creating block device resource of the distributed block device replication software, and activating the resource, so that the backup machine in the cluster is capable of synchronizing data with the host in the cluster.

4. The method of claim 3, wherein the step C) comprises:
installing the high availability cluster component in the host and the backup machine of the cluster, and setting up configuration information for the installed high availability cluster component, so that the host and the backup machine are switchable to each other to provide uninterrupted services resource when a fault occurs, the configuration information comprising heartbeat interval, broadcast interface, heartbeat delay time, switching time, a host node name and a backup machine node name.

5. The method of claim 4, wherein the step E) comprises:
configuring at the host and the backup machine respectively a host and a backup machine cluster resource information of the cluster, so that the host and the backup machine are switchable to each other via virtual IP and the slave is capable of accessing to the database services provided by the host and the backup machine by using the virtual IP, the information comprising a master node, a cluster virtual IP, a subnet mask, a broadcast address, and started services of a specified dual system.

6. The method of claim 1, wherein each of the software is installed in a source installation manner when building the environment.

7. The method of claim 5, further comprising:
generating a shell script for combination steps for each of components during building the environment, the shell script comprising at least functions of starting, stopping and checking status.

8. A high availability and high performance database cluster system comprising a high availability cluster and a high performance cluster, wherein
the high availability cluster comprises a host and a backup machine, in which a distributed block device replication software, a high availability cluster component, and a dependent package of MySQL multi-master software are installed, and in which an environment of a distributed block device replication software module, a high availability cluster component module and a database multi-master module is built, wherein the distributed block device replication software module enables the backup machine to synchronize data with the host, and the high availability cluster component module enables the backup machine to monitor the working status of the host; and
the high performance cluster further comprises a virtual IP host and at least one slave, the slave is installed with the database multi-master module, wherein the high availability cluster component module comprises a resource definition unit which defines resources of the host and backup machine of the high availability cluster, so that the host and the backup machine are switchable to each other, the slave being capable of accessing to database of the host and the backup machine to provide uninterrupted database cluster services.

9. The system of claim 8, wherein, the database comprises MySQL, Oracle and DB2.

10. The system of claim 9, wherein the distributed block device replication software module further comprises a configuration information unit configured to perform a configuration setting for a configuration file of the installed distributed block device replication software on the host and the backup machine, create a device resource of the distributed block device replication software, and activate the resource, so that the backup machine is capable to synchronize data from the host.

11. The system of claim 10, wherein the high availability cluster component module comprises a configuration information unit configured to set up configuration information for the high availability cluster component installed in the host and the backup machine, so that the host and the backup machine are switchable to each other to provide uninterrupted services resource when a fault occurs, the configuration information comprising a heartbeat interval, a broadcast interface, a heartbeat delay time, a switching time, a host node name and a backup machine node name.

12. The system of claim 11, wherein a host and a backup machine cluster resource information of the cluster system is configured through the resource definition unit, so that the host and the backup machine are switchable to each other via virtual IP and the slave is capable of accessing to database of the host and the backup machine by using the virtual IP, the cluster resource information comprising a master node, a cluster virtual IP, a subnet mask, a broadcast address, and started services of a specified dual system.

13. The system of claim 8, further comprising:
a script generation module implemented by a process and configured to write combination steps for each of components during building the cluster system environment to generate a shell script, the shell script comprising at least functions of starting, stopping and checking status.
